(19) United States
(12) Patent Application Publication
(10) Pub. No.: US 2025/0365308 A1
(43) Pub. Date: Nov. 27, 2025

(54) Lookalike Domain Phishing Detection

(71) Applicant: Zscaler, Inc., San Jose, CA (US)

(72) Inventors: Dani Rubin, Yokneam Illit (IL); Shoham Danino, Tel Aviv (IL)

(73) Assignee: Zscaler, Inc., San Jose, CA (US)

(21) Appl. No.: 19/289,975

(22) Filed: Aug. 4, 2025

Related U.S. Application Data
(63) Continuation-in-part of application No. 18/901,192, filed on Sep. 30, 2024.
Application No. 18/901,192 is a continuation-in-part of application No. 18/652,031, filed on May 1, 2024.
(63) Continuation-in-part of application No. 18/624,791, filed on Apr. 2, 2024.

(51) Int. Cl. H04L 9/40; H04L 41/16

(52) U.S. Cl. CPC H04L 63/1433; H04L 41/16; H04L 63/1483

(57) ABSTRACT

The present disclosure enhances domain lookalike detection by integrating a phishing risk assessment score into a multi-layered evaluation framework. The method systematically generates lookalike domains through genetic algorithms. Registered domains undergo advanced phishing analysis, incorporating domain and URL checks, technical infrastructure assessments, content inspections, and reputation-based intelligence to calculate a dynamic phishing score. A comprehensive risk score is then determined by merging phishing likelihood with business attributes, graphical/contextual similarity metrics, and domain registration patterns. Domains are categorized into predefined risk levels including phishing, registered, preventative, company-owned, or watchlist, with specific action recommendations provided for each category. The system generates prioritized alerts for high-risk domains, offering customers actionable intelligence to mitigate threats. By combining phishing-specific indicators with contextual evaluations, this solution improves detection accuracy, reduces false positives, and enables organizations to respond effectively to domain-based threats in real time, addressing evolving cybersecurity challenges.

### CROSS-REFERENCE TO RELATED APPLICATION(S)

The present disclosure is a continuation-in-part of U.S. patent application Ser. No. 18/901,192, filed Sep. 30, 2024, entitled “Systems and methods for generating lookalike Uniform Resource Locators (URLs) Based on Graphical Similarity Pixel Comparison,” which is a continuation-in-part of U.S. patent application Ser. No. 18/652,031, filed May 1, 2024, entitled “Systems and methods for generating lookalike Uniform Resource Locators (URLs) based on penalty-based genetic algorithms,” which is a continuation-in-part of U.S. patent application Ser. No. 18/624,791, filed Apr. 2, 2024, entitled “Systems and methods for generating and utilizing lookalike Uniform Resource Locators (URLs),” the contents of which are incorporated by reference in their entirety.

### FIELD OF THE DISCLOSURE

The present disclosure generally relates to network and cloud security. More particularly, the present disclosure relates to systems and methods for lookalike domain phishing detection.

### BACKGROUND OF THE DISCLOSURE

Phishing remains one of the most pervasive and damaging cybersecurity threats, with attackers increasingly relying on domain lookalikes to deceive users and steal sensitive information. These deceptive domains mimic legitimate ones through minor variations in spelling, structure, or appearance to exploit human error and bypass traditional defenses. Existing domain lookalike detection methods, such as visual similarity metrics and contextual matching algorithms, often suffer from high false-positive rates and a lack of actionable intelligence, limiting their effectiveness in distinguishing benign lookalike domains from malicious ones. Additionally, these approaches typically overlook key phishing-specific indicators, making it difficult for organizations to prioritize their response to genuine threats. As phishing techniques evolve and grow more sophisticated, there is a critical need for a more comprehensive and accurate solution to detect and assess the risks posed by lookalike domains, enabling organizations to protect users effectively and allocate their resources efficiently.

### BRIEF SUMMARY OF THE DISCLOSURE

The present disclosure provides advanced systems and methods for domain lookalike detection that integrates a phishing risk assessment score into a multi-layered evaluation framework for improved accuracy and actionability. The process begins with the systematic generation of lookalike domains using genetic algorithms that create permutations mimicking legitimate domains. Registered domains are subjected to detailed phishing analysis, leveraging metrics such as domain and Uniform Resource Locator (URL) characteristics, technical infrastructure integrity, content inspection, and reputation-based intelligence to calculate a phishing score.

This phishing score is dynamically weighted and combined with other factors, including external domain verification, graphical and contextual similarity metrics, domain registration patterns, and business attributes, to produce a final risk score. Based on this score, domains are categorized into risk levels such as Phishing, Registered, Preventative, Company-Owned, or Watchlist, with tailored action recommendations provided for each category.

Prioritized alerts are generated for high-risk domains, offering actionable insights to customers for mitigation. By incorporating phishing-specific indicators along with similarity and contextual evaluations, this invention reduces false positives, enhances threat prioritization, and gives organizations a powerful tool for combating domain-based phishing threats in evolving cybersecurity landscapes.

### BRIEF DESCRIPTION OF THE DRAWINGS

The present disclosure is illustrated and described herein with reference to the various drawings, in which reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a process for generating and utilizing lookalike domains.

FIG. 6 is a flow diagram of a process for generating and utilizing lookalike domains based on penalty values.

FIG. 7 is a tabular view of example of comparing pixelated images for a graphical comparison.

FIG. 8 is a flowchart of a process for generating and utilizing lookalike domains based on graphical comparison in accordance with another aspect of the present disclosure.

FIG. 9 is a flowchart of a process for domain lookalike phishing detection.

### DETAILED DESCRIPTION OF THE DISCLOSURE

Again, the present disclosure introduces systems and methods for advanced domain lookalike detection by integrating a phishing risk assessment score into a multi-layered analysis framework. The system generates permutations of lookalike domains and evaluates registered ones using a combination of phishing-specific indicators, similarity metrics, business attributes, and reputation-based intelligence. A dynamic risk score is calculated, prioritizing high-confidence phishing signals, and domains are categorized into actionable risk levels such as Phishing or Watchlist. The system generates prioritized alerts for high-risk domains, providing customers with clear threat assessments and recommended actions. By reducing false positives and improving detection accuracy, this solution empowers organizations to effectively address domain-based phishing threats.

### § 1.0 Cybersecurity Monitoring and Protection Examples

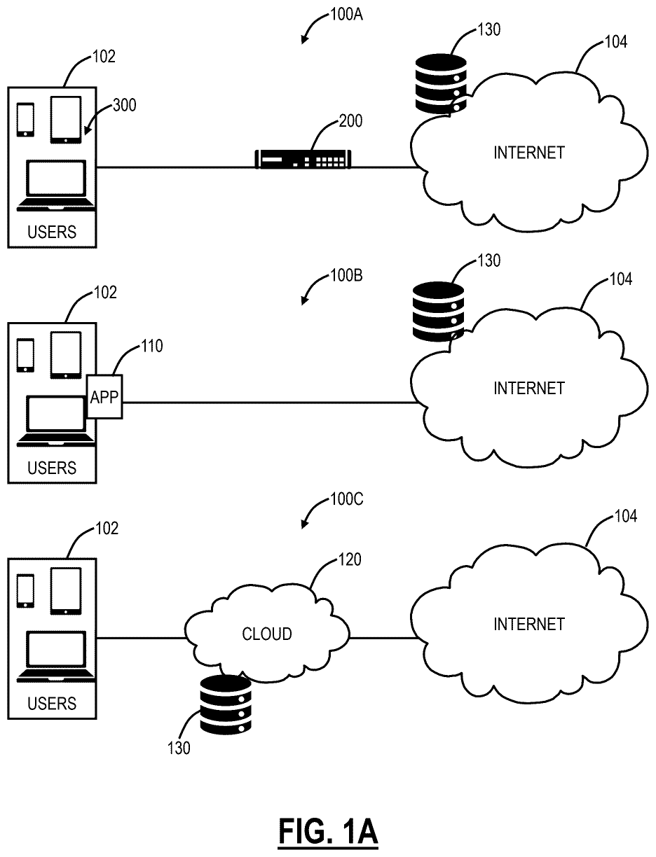

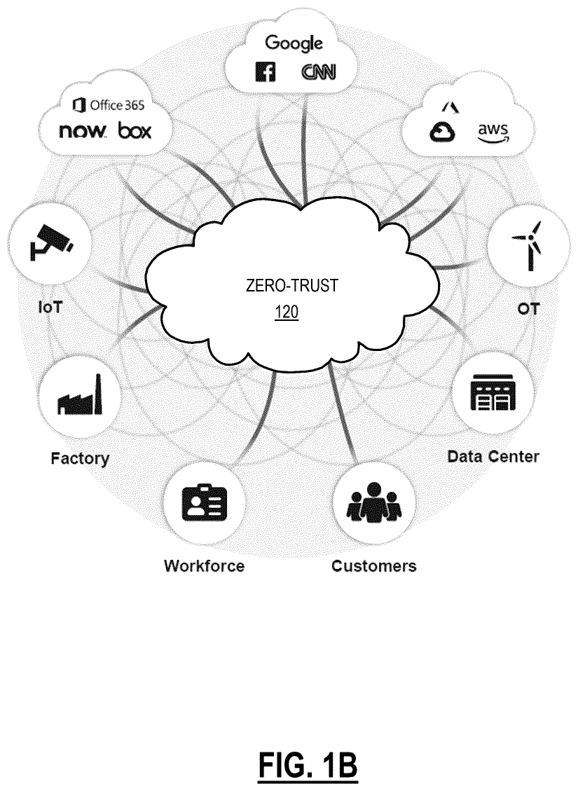

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

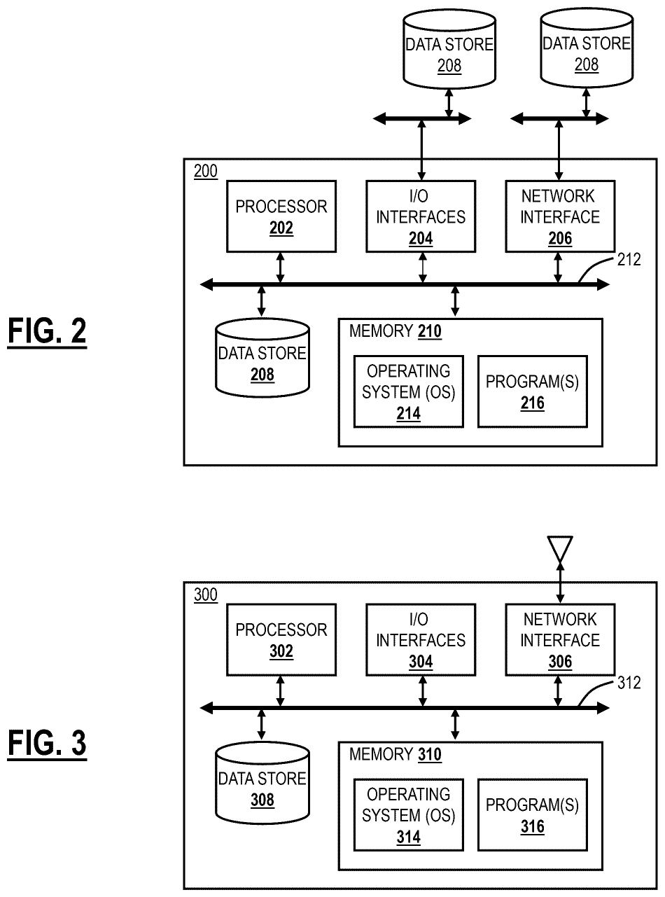

Note, the term endpoint 102 is used herein to refer to any computing device (see FIG. 3 for an example computing device 300) which can communicate on a network. The endpoint 102 can be associated with a user and includes laptops, tablets, mobile phones, desktops, etc. Further, the endpoint can also mean machines, workloads, loT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located in line with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication-not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates-in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. Patent Application No. 16/851, 161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

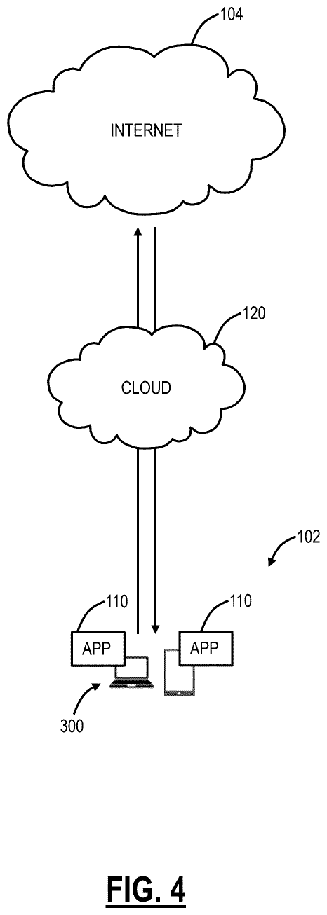

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Lookalike Domain Generation

The present disclosure relates to systems and methods for generating similar/lookalike domains for the purpose of cybersecurity. The ability to generate and identify lookalike domains/Uniform Resource Locators (URLs) for anti-phishing services is a widely sought after capability. By mimicking the facade of a legitimate website that is associated with the targeted company/destination, attackers use these lookalike URLs to deceive users. The identification of such lookalike URLs is important due to the high impact they can have on customer traffic.

By allowing companies to identify such lookalike URLs, even during the registration process, the impact of phishing sites can be greatly reduced. Similarly, during inline monitoring of user traffic, i.e., via the various network configurations described herein, the present systems can identify such lookalike URLs and perform one or more actions to limit or block access to potentially malicious sites. That is, the present systems can be adapted to, for each tenant associated with the cloud 120, generate a plurality of lookalike URLs based on the tenant's domains, and monitor traffic to block access to any of the plurality of lookalike URLs. Similarly, the systems can be adapted to determine any legitimate URLs accessed by users associated with each tenant, generate lookalike URLs based thereon, and block access to any of the lookalike URLs for protection of enterprise and user data.

In various embodiments, the present systems and methods can be implemented during the domain registration process. For example, identifying a registered lookalike URL is a potential threat to a company and can be used to predict an upcoming phishing attack which is adapted to target the company. A lookalike URL which is not yet registered can allow the company to proactively purchase it as a defense against future attacks.

Traditionally, the identification of lookalike URLs utilize already registered URLs by querying known registered URLs for identifying similar strings. In such approaches, the methods compare already registered domains to a company's online assets, then identify any similar domains according to a similarity metric. Although widely used, such methods focus solely on yielding already registered domains and are not adapted to suggest domains for proactive measures against potential future attacks as described.

Other traditional approaches may be adapted to generate similar URLs based on common deception methods such as Top-Level Domain (TLD) swap, character repetition, or graphically similar characters. While these approaches may suggest not-yet-registered domains, they are typically limited to one deception method. This is because any attempts to combine more deception methods together yields such a large number of potential strings, it can take a computer an excessively large amount of time to generate. Further, such methods generate combinations that are so far from the original URL, that it makes most of the generated lookalike URLs irrelevant. Thus, most traditional methods only utilize one known deception method at a time to generate lookalike URL options.

Because of the above mentioned deficiencies, the present disclosure provides systems and methods for generating and identifying lookalike URLs which can be registered or not registered based on combinations of deception methods. In various embodiments, the capabilities of the present systems and methods are enabled by employing genetic algorithms to generate meaningful lookalike URLs. By utilizing genetic algorithms, the present systems can generate and uncover registered URLs and unregistered URLs with a combination of more than one deception method per lookalike URL with a short computation time. That is, the present methods can generate a population of lookalike URLs, where the population of lookalike URLs can include both registered and unregistered URLs which involve potentially large numbers of deception methods within a relatively short computation time.

### § 5.1 Genetic Algorithm for Generating Lookalike Domains

In various embodiments, the present systems and methods utilize genetic algorithms for generating a population of meaningful lookalike domains based on an original target domain. That is, the present processes can be initiated responsive to receiving an original target domain, i.e., the cloud 120 performs the present processes for domains associated with its tenants, domains frequently visited by users, etc. The original target domain is represented as a vector of strings having a size equal to the domain length +3. For example, a domain (exampleurl.com) has the second-level domain “exampleurl” which has 10 characters. Based thereon, the vector representing this domain will have a string size of 10+3. The 3 additional characters are based on the following. The first character is a prefix, the character before the last is a postfix, and the last character is the Top-Level Domain (TLD), i.e., “.com”. The characters between the prefix and postfix are the original Second-Level Domain (SLD) “exampleurl”. For example, an illustration of a vectorized representation of the original URL (exampleurl.com) can be as follows:

| Index | Value |
|---|---|
| 1 | [ ] |
| 2 | [e] |
| 3 | [x] |
| 4 | [a] |
| 5 | [m] |
| 6 | [p] |
| 7 | [l] |
| 8 | [e] |
| 9 | [u] |
| 10 | [r] |
| 11 | [l] |
| 12 | [ ] |
| 13 | [.com]] |

The 1st and 12th values are left blank, as there is no prefix or postfix at this time.

To generate an initial population (first generation) of lookalike URLs, the following steps are performed. The initial population of lookalike URLs involves the generation of similar strings, each with a single deception method. The deception methods used can include, but are not limited to, predefined TLD swap, repetition of a character, omission of a character, added hyphens, added letters, added numbers, extending the URL with a common postfix, and the like. The output from each deception method is in the vectorized format shown above. For example, when considering the original/target domain “exampleurl.com”, and a plurality of deception methods, the following list of lookalike domains can be generated.

| Lookalike URL | Vectorized | Method |
|---|---|---|
| exampleuarl.com | [[ ], [e], [x], [a], [m], [p], [l], [e], | Mid |
| | [u], [ar], [l], [ ], [.com]] | Insertion |
| anexampleurl.com | [[an], [e], [x], [a], [m], [p], [l], | Prefix |
| | [e], [u], [r], [l], [ ], [.com]] | |
| exampleurlonline.com | [[ ], [e], [x], [a], [m], [p], [l], [e], | Extension |
| | [u], [r], [l], [online], [.com]] | |
| example-url.com | [[ ], [e], [x], [a], [m], [p], [l], | Hyphenation |
| | [e], [−u], [r], [l], [ ], [.com]] | |
| exampleu-rl.com | [[ ], [e], [x], [a], [m], [p], [l], | Hyphenation |
| | [e], [u], [−r], [l], [ ], [.com]] | |
| exmpleurl.com | [[ ], [e], [x], [ ], [m], [p], [l], | Omission |
| | [e], [u], [r], [l], [ ], [.com]] | |
| examplleurl.com | [[ ], [e], [x], [a], [m], [p], [ll], | Repetition |
| | [e], [u], [r], [l], [ ], [.com]] | |
| exaampleurl.com | [[ ], [e], [x], [aa], [m], [p], [l], | Repetition |
| | [e], [u], [r], [l], [ ], [.com]] | |
| exampleurl.net | [[ ], [e], [x], [a], [m], [p], [l], | TLDSwap |
| | [e], [u], [r], [l], [ ], [.net]] | |
| exampleurl.org | [[ ], [e], [x], [a], [m], [p], [l], | TLDSwap |
| | [e], [u], [r], [l], [ ], [.org]] | |

The above table shows a plurality of generated lookalike URLs based on the parent URL (exampleurl.com). Each of the generated lookalike URLs in this first generation are generated based on a single deception method. The alteration of each of the lookalike URLs is bolded for ease of viewing. For example, the lookalike URL “exampleuarl.com” includes an insertion of the letter a as shown. It will be appreciated that each of the generated lookalike URLs all have the same “chromosome” length (same number of values), i.e., vectorized values as the parent URL vectorized representation.

Each of the generated lookalike URLs is assigned a similarity score associated with the original/parent URL. That is, the similarity of each of the generated lookalike URLs to the original URL is calculated. In various embodiments, this similarity score can be generated based on Levenshtein distance, or any other distance metric process of the like such as, but not limited to, graphical similarity, context, phonetic closeness, indices of change, and length of string. The similarity score of each of the generated lookalike URLs can include the following scores.

| Lookalike URL | Vectorized | Similarity |
|---|---|---|
| exampleuarl.com | [[ ], [e], [x], [a], [m], [p], [l], | 0.7 |
| | [e], [u], [ar], [l], [ ], [.com]] | |
| anexampleurl.com | [[an], [e], [x], [a], [m], [p], | 0.6 |
| | [l], [e], [u], [r], [l], [ ], [.com]] | |
| exampleurlonline.com | [[ ], [e], [x], [a], [m], [p], [l], | 0.72 |
| | [e], [u], [r], [l], [online], [.com]] | |
| example-url.com | [[ ], [e], [x], [a], [m], [p], [l], | 0.9 |
| | [e], [−u], [r], [l], [ ], [.com]] | |
| exampleu-rl.com | [[ ], [e], [x], [a], [m], [p], | 0.2 |
| | [l], [e], [u], [−r], [l], [ ], [.com]] | |
| exmpleurl.com | [[ ], [e], [x], [a], [m], [p], | 0.75 |
| | [l], [e], [u], [r], [l], [ ], [.com]] | |
| examplleurl.com | [[ ], [e], [x], [a], [m], [p], [ll], | 0.68 |
| | [e], [u], [r], [l], [ ], [.com]] | |
| exaampleurl.com | [[ ], [e], [x], [aa], [m], [p], [l], | 0.74 |
| | [e], [u], [r], [l], [ ], [.com]] | |
| exampleurl.net | [[ ], [e], [x], [a], [m], [p], [l], | 0.71 |
| | [e], [u], [r], [l], [ ], [.net]] | |
| exampleurl.org | [[ ], [e], [x], [a], [m], [p], [l], | 0.8 |
| | [e], [u], [r], [l], [ ], [.org]] | |

From this first generation of lookalike URLs, a set of parents must be selected in order to generate a second generation. In various embodiments, parents can be selected from the first generation based on the similarity score of each of the lookalike URLs. More particularly, in various embodiments, a plurality of parents are selected from the first generation of lookalike URLs based on their similarity score being above a threshold. The first generation of lookalike URLs is filtered based on this threshold, where the URLs which have a similarity score above the threshold are used as parents for generating the second generation. In this present example, the similarity threshold is contemplated as 0.71, leaving the following lookalike URLs to be used as parents of the second generation.

| Lookalike URL | Vectorized | Similarity |
|---|---|---|
| exampleurlonline.com | [[ ], [e], [x], [a], [m], [p], [l], | 0.72 |
| | [e], [u], [r], [l], [online], [.com]] | 0.9 |
| example-url.com | [[ ], [e], [x], [a], [m], [p], | |
| | [l], [e], [−u], [r], [l], [ ], [.com]] | |
| exmpleurl.com | [[ ], [e], [x], [ ], [m], [p], | 0.75 |
| | [l], [e], [u], [r], [l], [ ], [.com]] | |
| exaampleurl.com | [[ ], [e], [x], [aa], [m], [p], | 0.74 |
| | [l], [e], [u], [r], [l], [ ], [.com]] | |
| exampleurl.net | [[ ], [e], [x], [a], [m], [p], | 0.71 |
| | [l], [e], [u], [r], [l], [ ], [.net]] | |
| exampleurl.org | [[ ], [e], [x], [a], [m], [p], | 0.8 |
| | [l], [e], [u], [r], [l], [ ], [.org]] | |

It will be appreciated that any similarity score threshold can be utilized, and the present threshold of 0.71 shall be contemplated as a non-limiting example.

Once a set of parents is selected as described above, the second generation of lookalike URLs can be generated. The production of a new lookalike URL is based on two or more parents, where each character of the vector is chosen at random or alternatively with a weighted probability. That is, the weight of a character can be increased based on that character having a deception therein or based on the similarity of the deception. For example, an offspring of the parents “example-url.com” and “exmpleurl.com” may be “exmple-url.com” based on the following selections.

| Parents | Offspring |
|---|---|
| [[ ], [e], [x], [a], [m], [p], [l], | [[ ], [e], [x], [ ], [m], [p], [l], |
| [e], [−u], [r], [l], [ ], [.com]] | [e], [−u], [r], [l], [ ], [.com]] |
| [[ ], [e], [x], [ ], [m], [p], [l], | |
| [e], [u], [r], [l], [ ], [.com]] | |

The selected characters from each parent are bolded to show the character selection process.

In another example, an offspring of the parents “exampleurlonline.com” and “exampleurl.net” may be “exampleurlonline.net” based on the following selections.

| Parents | Offspring |
|---|---|
| [[ ], [e], [x], [a], [m], [p], [l], [e], | [[ ], [e], [x], [a], [m], [p], [l], |
| [u], [r], [l], [online], [.com]] | [e], [u], [r], [l], [online], [.net]] |
| [[ ], [e], [x], [a], [m], [p], [l], | |
| [e], [u], [r], [l], [ ], [.net]] | |

Again, the selected characters from each parent are bolded to show the character selection process. The above described offspring generation methods can be utilized for each pairing of parents from the first generation to generate a set of lookalike URLs for the second generation. Thus far, the second generation includes the lookalike URLs “exmple-url.com” and “exampleurlonline.net”. It is noted that each of these lookalike URLs in the second generation now each include 2 deception techniques therein. For example, the lookalike URL “exampleurlonline.net” includes an extension and a TLD swap, i.e., it includes the extension of “online” and the TLD swap of “.net”.

The deception methods/techniques and similarity of the evolved population (second generation) is based on the attributes of the parents. For example, the similarity may reflect a multiplication or any other function of the parents' similarity. The deception methods will include all deception methods that are attributed to each of the chosen indices. For example, given the offspring in the second generation which includes both of the deception methods of its parents, the methods are [extension, TLD swap] and the similarity is 0.72*0.71=0.5112. The lookalike URLs of the second generation and their associated deception methods and similarity scores are shown below.

| URL | Vectorized | Method | Similarity |
|---|---|---|---|
| exmple-url.com | [[ ], [e], [x], [ ], [m], | Omission, | 0.648 |
| | [p], [l], [e], [−u], [r], | Hyphenation | |
| | [l], [ ], [.com]] | | |
| exampleurlonline.net | [[ ], [e], [x], [a], [m], | Extension, | 0.5112 |
| | [p], [l], [e], [u], [r], [l], | TLD Swap | |
| | [online], [.net]] | | |

The offspring, i.e., the lookalike URLs within the second generation can then be filtered for determining parents of a third generation. The filtering can be based on their respective similarity score, i.e., based on a similarity threshold, or based on any of number of deception methods, minimum or maximum string length, strings that cannot be registered as a URL, etc. For example, lookalike URLs within the second generation, or any other generation, can be discarded if they have too many deception methods utilized therein, have characteristics that prohibit it from being registered as a URL, etc. In the present example, the offspring are filtered based on their similarity score, i.e., based on a similarity score threshold of 0.55. That is, only offspring having a similarity score above 0.55 are retained as the second generation. Thus, the second generation of lookalike URLs is shown below.

| URL | Vectorized | Method | Similarity |
|---|---|---|---|
| exmple-url.com | [[ ], [e], [x], [ ], [m], [p], [l], | Omission, | 0.648 |
| | [e], [−u], [r], [l], [ ], [.com]] | Hyphenation | |

The process described herein can then be repeated to generate any number of N generations, N being an integer. That is, the selection of parents, generation of offspring, filtering of offspring is repeated until a specific condition is met. Such a condition can be that no new offspring yield a similarity score above a threshold, the condition can be a set number of generations, and the like, wherein the integer N is based thereon. For example, the process can be repeated until no new offspring have a similarity score above a threshold, or the process can be repeated until a specific number of generations is achieved.

### § 5.2 Utilizing Generated Lookalike Domains

The generated lookalike URLs from each generation can be logged and utilized for performing various functions within the cloud 120. For example, the lookalike URLs can be displayed via a User Interface (UI) to enterprises utilizing the cloud 120, wherein the lookalike URLs are generated based on the enterprise's domains. That is, the original target domain from which the various generations of lookalike URLs are generated is associated with the enterprise, and the generated lookalike URLs are presented to the enterprise within a report. This report can include each of the generated and filtered lookalike URLs from the processes described above, and can further include, for each lookalike URL, the deception methods used to generate it, whether it is registered, who it was registered by, whether it is associated with a known phishing site, and any actions that can be taken to reduce risk associated with the lookalike URL. An example action can include providing the enterprise the ability to purchase any unregistered lookalike URLs as a precautionary measure.

Additionally, the URL filtering of the cloud 120 can leverage the lookalike URLs generated for legitimate sites. That is, the cloud 120 can block, allow, or limit website access based on known/generated lookalike URLs. For example, by monitoring traffic of users through the cloud 120, the cloud 120 can block access to known lookalike URLs, the known lookalike URLs being generated lookalike URLs that are known to be registered. That is, the present systems can be adapted to, for each tenant associated with the cloud 120, generate a plurality of lookalike URLs based on the tenant's domains, and monitor traffic to block access to any of the plurality of lookalike URLs. Similarly, the systems can be adapted to determine legitimate URLs frequently accessed by users associated with each tenant, generate lookalike URLs based thereon, and block access to any of the lookalike URLs for protection of enterprise and user data.

### §5.3 Process for Generating and Utilizing Lookalike Domains

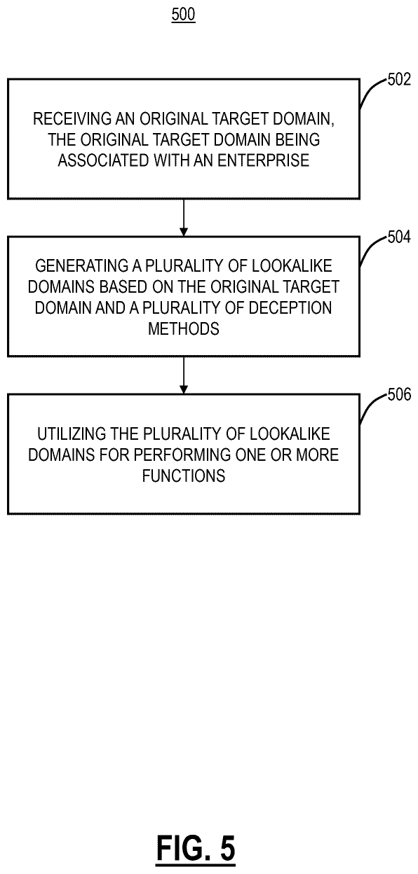

FIG. 5 is a flow diagram of a process 500 for generating and utilizing lookalike domains. The process 500 includes receiving an original target domain, the original target domain being associated with an enterprise, i.e., a tenant of the cloud (step 502); generating a plurality of lookalike domains based on the original target domain and a plurality of deception methods (step 504); and utilizing the plurality of lookalike domains for performing one or more functions, i.e., via the cloud (step 506).

The process 500 can further include wherein the generating includes utilizing a genetic algorithm to generate the plurality of lookalike domains. The generating can include generating a first generation of lookalike domains, each including a deception method therein, and wherein the plurality of lookalike domains includes the first generation of lookalike domains. The steps can further include computing a similarity score for each of the lookalike domains in the first generation of lookalike domains, wherein the similarity score represents a similarity between each of the lookalike domains in the first generation of lookalike domains and the original target domain. The steps can further include selecting a set of parents from the first generation of lookalike domains; generating a second generation of lookalike domains based on the selected set of parents, wherein the plurality of lookalike domains includes the first generation of lookalike domains and the second generation of lookalike domains; and computing a similarity score for each of the lookalike domains in the second generation of lookalike domains. The selecting can include selecting parents from the first generation of lookalike domains based on their respective similarity score being above a threshold. The selecting, generating, and computing can be repeated until a preconfigured number of generations is reached or until no similarity score of the lookalike domains is above a threshold. The similarity score of each of the lookalike domains in the second generation of lookalike domains can be the result of a multiplication of its parent's similarity scores. The one or more functions can include providing a report to the tenant, wherein the report includes each of the plurality of lookalike domains, the deception methods used to generate each of the plurality of lookalike domains, whether each of the plurality of lookalike domains is registered, who it is registered by, and whether each of the plurality of lookalike domains is associated with a known phishing site.

### § 6.0 Penalties for Lookalike URLs

The present disclosure describes systems and methods for utilizing genetic algorithms to uncover both registered and unregistered lookalike URLs. By utilizing the present systems, the cloud 120, via its various components and security services, is adapted to introduce and enforce policies based on lookalike URLs which include more than a single deception method to a given character, while avoiding high computational complexity experienced by traditional bootstrap approaches.

The processes described herein utilize similarity scores assigned to each lookalike URL within a generation. As described, these similarity scores are used for filtering irrelevant lookalike URLs, and for filtering to determine parents of a subsequent generation via a parent selection process. When filtering irrelevant lookalike URLs, URLs with a low similarity score will not be considered as good candidates and will be removed from the pool of lookalike URLs. When filtering for determining parents of a subsequent generation, URLs with a similarity score below a threshold will not be removed from the pool of lookalike URLs but will not be selected as parents of a subsequent generation.

In various embodiments, a novel process for determining a penalty value for each of the generated lookalike URLs is contemplated. This penalty is based on a graphical distance, phonetic distance, and context distance, in the scope of position and URL. Based thereon, the similarity score of a lookalike URL is the inverse of the penalty for the lookalike URL. This represented by the following equation.

$$Simila {rity}_{Lookalike URL} = 1 - {Penalty}_{Lookalike URL}$$

The process of generating vectorized lookalike URLs involves utilizing various deception methods, each of which incorporates specific deception penalties based on different aspects of the URL changes. For instance, the mid insertion deception technique applies deception penalties based on the graphical alterations observed within the string of the URL. This method evaluates the visual discrepancies that occur when characters are inserted into the middle of the URL, affecting its appearance and potentially misleading users.

Similarly, the TLD swap method imposes deception penalties based on the contextual relevance of the new domain. This approach assesses how swapping the TLD (such as changing .com to .net) might affect the perceived legitimacy or relevance of the URL, considering factors such as the commonness of the TLD or its association with certain types of websites.

The vowel swap deception method targets the phonetic sound of the URL. Deception penalties are assigned based on changes to the URL's phonetics that occur when vowels within the domain name are swapped. This method specifically looks at how such alterations might confuse users by maintaining a similar auditory representation, even though the spelling of the URL has been modified. Each of these methods utilizes a specific deception penalty mechanism tailored to address aspects of deception, aiming to create effective lookalike URLs that can be used in various cybersecurity applications.

Each lookalike URL is assigned a deception penalty for each deception included therein, as shown in the following table.

| | | Penalty | Deception |
|---|---|---|---|
| Vectorized Lookalike URL | Method | Type | Penalty |
| [[ ], [e], [x], [a], [m], [p], [l], | Mid | Graphical | 0.8 |
| [e], [u], [ar], [l], [ ], [.com]] | Insertion | | |
| [[an], [e], [x], [a], [m], [p], | Prefix | Context | 0.4 |
| [l], [e], [u], [r], [l], [ ], [.com]] | | | |
| [[ ], [e], [x], [a], [m], [p], [l], | Extension | Context | 0.3 |
| [e], [u], [r], [l], [online], [.com]] | | | |
| [[ ], [e], [x], [a], [m], [p], [l], | Hyphenation | Context | 0.3 |
| [e], [−u], [r], [l], [ ], [.com]] | | | |
| [[ ], [e], [x], [a], [m], [p], [l], | Hyphenation | Context | 0.9 |
| [e], [u], [−r], [l], [ ], [.com]] | | | |
| [[ ], [e], [x], [ ], [m], [p], [l], | Omission | Graphical | 0.6 |
| [e], [u], [r], [l], [ ], [.com]] | | | |
| [[ ], [e], [x], [a], [m], [p], [ll], | Repetition | Graphical | 0.4 |
| [e], [u], [r], [l], [ ], [.com]] | | | |
| [[ ], [e], [x], [aa], [m], [p], | Repetition | Graphical | 0.5 |
| [l], [e], [u], [r], [l], [ ], [.com]] | | | |
| [[ ], [e], [x], [a], [m], [p], [l], | TLDSwap | Context | 0.5 |
| [e], [u], [r], [l], [ ], [.net]] | | | |
| [[ ], [e], [x], [a], [m], [p], [l], | TLDSwap | Context | 0.3 |
| [e], [u], [r], [l], [ ], [.org]] | | | |

The deception penalty is based on the deception method used for a particular lookalike URL. That is, in various embodiments, a deception penalty assigned to a lookalike URL is based on the deception method, where each deception method is associated with a particular deception penalty value. The deception penalty value of each deception method can be determined prior to execution of the present systems.

It will be appreciated that the deception penalty can be further based on the context between known words that a deception may separate. For example, in the case of the two hyphenation deception methods shown, the deception penalty further depends on the context between known words which the hyphen separates. When the words before and after the hyphen are unknown English words, the penalty will be higher. That is, “example-url.com” incurs a lower penalty than “exampleu-rl.com” even though they both include a single hyphenation.

Further, a positional coefficient, which is a function of the position of the alteration/deception and the length of the URL, is determined. The positional coefficient can be determined based on a distance of the alteration from an edge and the URL length, i.e., if the deception is in the 3^{rd} character of a URL, then the “distance from edge” value will be 3 and if the SLD includes 13 characters, then the “length” variable will be 13. It will be noted that the distance from the edge for prefix and postfix is defined to be 1. The following equation shows an embodiment for determining the positional coefficient of a lookalike URL based on the distance of the deception from an edge and the URL length. It will be appreciated that the following equation represents one embodiment for determining the positional coefficient, and in other embodiments, the positional coefficient can be determined based on any function of the deception position and the length of the lookalike URL.

$$coef ( position , length ) = clip ( \frac{C}{distance from {edge}^{a} \cdot {length}^{b}} , 0.1 , 1 )$$

In this example, C is a constant used to normalize the coefficient according to expected lengths of the lookalike URL. Further, a is a power given to the distance of the alteration from an edge. Finally, b is a power given to the URL length.

In various embodiments, a collective penalty can be determined for each of the lookalike URLs. This can be based on the presence of non-Latin characters in a lookalike URL, lookalike URLs that are too long or too short, the existence of more than one hyphen in a lookalike URL, etc. Again, the collective penalty is assigned to a lookalike URL as a whole, and is not assigned to a specific index/character of the lookalike URL as is done with the deception penalty and positional coefficient.

Further, a positional penalty of a given deception method is a function of the positional coefficient and the deception penalty. For example, the function can be represented as follows.

$${Positional\_Penalty}_{j} = coefficient \cdot deception\_penalty$$

For example, given a positional coefficient of 0.5, and a deception penalty of 0.5, the positional penalty will be 0.25. This function can be demonstrated by the following mathematical representation.

$${Positional\_Penalty}_{j} = 0.5 \cdot 0.5 = 0.25$$

Again, it will be appreciated that the present method for determining the positional penalty represents one embodiment, and in other embodiments, the positional penalty can be determined based on any function of the positional coefficient and the deception penalty of a character/index of a lookalike URL. The determination of a positional penalty is performed for each index of a lookalike URL. That is, each index that includes a deception will have a positional penalty assigned thereto, and in various embodiments, indexes that do not include a deception will be assigned a positional penalty of 0.

The one or more positional penalties can then be represented in a penalty vector, the penalty vector being based on the vectorized representation of the associated lookalike URL. Again, the position in the vector where the positional penalty is assigned to is based on the position of the deception method within the vectorial representation of the lookalike URL. For example, if the deception method is in position 3 of the lookalike URL, and the positional penalty is 0.25, the vectorized penalty is as follows.

| Vectorized Lookalike URL | Vectorized Penalty |
|---|---|
| [[ ], [e], [xx], [a], [m], [p], [l], | [[0], [0], [0.25], [0], [0], [0], |
| [e], [u], [r], [l], [ ], [.com] | [0], [0], [0], [0], [0], [0], [0]] |

The total penalty for a lookalike URL can therefore be determined as follows. In various embodiments, to determine the total penalty for a lookalike URL (lookalike URL penalty or penalty value), the present systems are adapted to determine the sum of all positional penalties associated with a lookalike URL. Further, if present, any collective penalties associated with the lookalike URL are summed as well. Finally, all positional penalties and collective penalties are summed to determine the lookalike URL penalty of an associated lookalike URL. This process can be represented by the following function.

$${Penalty}_{lookalike URL} = {\sum }_{i} {collective\_penalty}_{i} + {\sum }_{j} {penalty}_{j}$$

Utilizing the example lookalike URL described above with one positional penalty of 0.25, and assuming a collective penalty of 0.1 has been assigned thereto, the lookalike URL penalty of this example lookalike URL is described below.

$${Penalty}_{look alike URL} = 0.1 + 0.25 = 0.35$$

In various embodiments, the process described above is contemplated for use with an initial population of lookalike URLs. That is, in various embodiments, the process for determining lookalike URL penalties described above is utilized only for a first generation of lookalike URLs. Therefore, the following process is contemplated for determining lookalike URL penalties for lookalike URLs in subsequent generations.

For the lookalike URLs in a next generation that are created, offspring will also be assigned with the evolved vectorized penalty that is selected upon the same indexes of the generated lookalike URL. That is, the positional penalties of an offspring lookalike URL are based on the positional penalties of its parents. For example, such an evolution of the vectorized penalty may include the following.

| Parents | Vectorized Penalty |
|---|---|
| [[ ], [e], [x], [a], [m], [p], [l], | [[0], [0], [0], [0], [0], [0], |
| [e], [−u], [r], [l], [ ], [.com]] | [0], [0], [0.1], [0], [0], [0], [0]] |
| [[ ], [e], [x], [ ], [m], [p], [l], | [[0], [0], [0], [0.4], [0], [0], |
| [e], [u], [r], [l], [ ], [.com]] | [0], [0], [0], [0], [0], [0], [0]] |
| Offspring | Vectorized Penalty |
| [[ ], [e], [x], [ ], [m], [p], [l], | [[0], [0], [0], [0], [0], |
| [e], [−u], [r], [l], [ ], [.com]] | [0], [0], [0.1], [0], [0], [0], [0]] |

Therefore, for each index that an offspring “inherits” from its parents, as described herein, the positional penalty associated with that index is also inherited. Contrastingly, collective penalties are assigned for each offspring lookalike URL regardless of its parents collective penalties.

In order to determine the lookalike URL penalty of a lookalike URL in such a generation, i.e., not the first generation, the systems do not perform the process described above due to the possibility of the result being greater than 1. That is, the systems must output a lookalike URL penalty that is between 0 and 1. Thus, the systems can employ the following function for determining the lookalike URL penalty of lookalike URLs in subsequent generations and/or include a plurality of deception methods and positional penalties.

$${Penalty}_{Look alike URL} = min ( 1 , 1 - {\prod }_{i} ( 1 - p e n a l t {y}_{i} ) + {\sum }_{j} c o l l e c t i v {e}_{-} p e n a l t {y}_{j} )$$

Thus, the systems sum the compliments of each positional penalty, guaranteeing a higher penalty that is also between 0 and 1. Because the collective penalty can potentially drive the lookalike URL penalty to a number that is greater than 1, the systems clip the output, thereby ensuring an output between 0 and 1.

By utilizing the above described steps, the lookalike URL penalty of an offspring lookalike URL can be represented as follows.

| | | Collective | Lookalike |
|---|---|---|---|
| Parents | Vectorized Penalty | Penalty | URL Penalty |
| | [[0], [0], [0], [0.4], [0], [0], [0], | 0.05 | 0.15 |
| | [0], [0.1], [0], [0], [0], [0]] | | |
| | [[0], [0], [0], [0.4], [0], [0], [0], | | |
| | [0], [0], [0], [0], [0], [0]] | 0.05 | 0.45 |
| | | Collective | Lookalike |
| Offspring | Vectorized Penalty | Penalty | URL Penalty |
| | [[0], [0], [0], [0.4], [0], [0], [0], | 0.05 | 0.51 |
| | [0], [0.1], [0], [0], [0], [0]] | | |

It can be seen that the lookalike URL penalty of the offspring is larger than each of the lookalike URL penalties of its parents, but not a pure addition.

Again, the various processes described herein utilize similarity scores assigned to each lookalike URL within a generation. These similarity scores are used for filtering irrelevant lookalike URLs, and for filtering to determine parents of a subsequent generation via a parent selection process. When filtering irrelevant lookalike URLs, URLs with a low similarity score will not be considered as good candidates and will be removed from the pool of lookalike URLs. When filtering for determining parents of a subsequent generation, URLs with a similarity score below a threshold will not be removed from the pool of lookalike URLs but will not be selected as parents of a subsequent generation. Because of the close relationship between the described similarity scores and the lookalike URL penalties, the two concept can be utilized interchangeably. That is, the relationship between the similarity score of a lookalike URL and the lookalike URL penalty is an inverse relationship. Thus, when filtering irrelevant lookalike URLs, URLs with a high lookalike URL penalty will not be considered as good candidates and will be removed from the pool of lookalike URLs. When filtering for determining parents of a subsequent generation, URLs with a lookalike URL penalty above a threshold will not be removed from the pool of lookalike URLs but will not be selected as parents of a subsequent generation.

### § 6.1 Process for Generating Lookalike URLs With Penalty Values

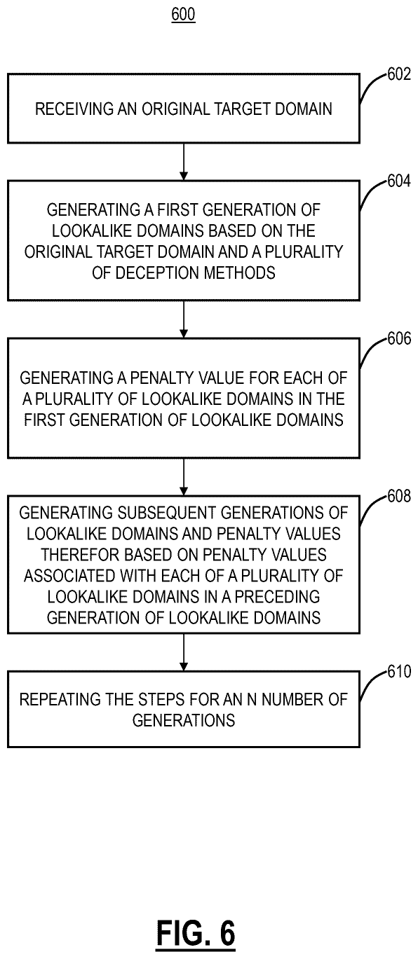

FIG. 6 is a flow diagram of a process 600 for generating and utilizing lookalike domains based on penalty values. The process 600 includes receiving an original target domain (step 602); generating a first generation of lookalike domains based on the original target domain and a plurality of deception methods (step 604); generating a penalty value for each of a plurality of lookalike domains in the first generation of lookalike domains (step 606); generating subsequent generations of lookalike domains and penalty values therefor based on penalty values associated with each of a plurality of lookalike domains in a preceding generation of lookalike domains (step 608); and repeating the steps for an N number of generations (step 610).

The process 600 can further include utilizing the lookalike domains for performing one or more functions. The generating can include utilizing a genetic algorithm to generate the plurality of lookalike domains. Each of the lookalike domains in the first generation of lookalike domains can include a deception method therein. Generating the penalty value for each of the plurality of lookalike domains in the first generation can further include generating a deception penalty for each deception in a lookalike domain; generating a positional coefficient for each deception in the lookalike domain; determining a positional penalty for each character in the lookalike domain based on the deception penalty and positional coefficient; and determining the penalty value of the lookalike domain based on one or more positional penalties associated therewith and a collective penalty. The penalty value for each of the plurality of lookalike domains in subsequent generations can be based on the one or more positional penalties of its parents and a collective penalty. The collective penalty of an offspring lookalike domain can be independent of the collective penalties of its parents. Generating subsequent generations of lookalike domains can further include selecting a set of parents from a preceding generation of lookalike domains based on their penalty values; and generating the subsequent generation of lookalike domains based thereon. The selecting can include selecting parents from the preceding generation of lookalike domains based on their respective penalty value being below a threshold. The selecting and generating can be repeated until no penalty value of a lookalike domain in a subsequent generation of lookalike domains is below a threshold.

### § 7.0 Graphical Similarity Pixel Comparison

One aspect of the present disclosure generally includes providing a similarity score between two domains based on a graphical comparison. Moreover, the instant disclosure provides methods and systems for generating a list of lookalike domains to prevent phishing attacks, wherein the lookalike domains are discovered by way comparing an image associated with the image. Advantageously, the methods can be used to warn and alert a customer of potential attacks and prevent future attacks. The method can relate an image associated with the original target domain and an image associated with a lookalike domain and provide scores that are specific to each. As a result of such graphical comparison, the scores can be unique to any domain referenced. Moreover, rather than predefined constants, a similarity, such as a graphical similarity can be directly calculated. In some aspects, a sliding window logic can be employed which can further enhance the accuracy of the score. The graphical similarity contemplated in this disclosure can be more reliable than other comparisons available in the art, and therefore, the quality of user customer protection can be enhanced. For example and without limitation, disclosure can provide alerting a customer based on the similarity score. The alert can be based on a threshold which is determined by the similarity score. Because the determination is more accurate, the threshold can be increased. As a result, likelihood of phishing attack prevention is increased.

General aspects of the disclosure pertain to attack prevention based on domains. As used herein, the term “domain” generally refers to a portion of a website's address which can be recognized and associated with the website or organization. Domains are important in phishing prevention because legitimate websites usually have well-known and trusted domains. Phishing attacks may leverage this association by way of using deceptive domains which are similar or substantially similar to the well-known domain to trick users. Domain lookalikes can refer to such domains provided by attackers which are similar to the original domains. Domain lookalikes can discover potential lookalike domains of the customer that might be used for phishing attacks. Some aspects of the disclosure can include alerting a customer to a potential phishing attack. The alert can be broadcast directly or indirectly to the customer and can be displayed over a plurality of mediums. For example, the alert can be a graphical display or a text-based message pushed to the customer. The alert can be a browser warning, wherein a web browser can display a warning message or warning alert which can generally indicate suspicious websites. The alert can be an email to the customer or a direct contact through a device. Other methods of providing an alert can include without limitation: email client alerts, security software alerts, two-factor authentication alerts, quarantine, link hover and preview alerts, pop-up or desktop alerts, or the like.

The alerting can be based on a threshold. The threshold can set a minimum requirement to send the alert. The idea is to limit the number of alerts which are related to non-threatening domains. By increasing the threshold, the likelihood of the domains that illicit an alert being actually malicious is increased. The threshold can be based on a score, such as a similarity score. For example, the threshold can include sending the alert when the score is at least a predefined value. In other words, the threshold can be a margin based on the score.

Some aspects of the instant disclosure can include generating a list of lookalike domains. The list can be generated as described in the methods herein. For example, a list of one or more lookalike domains can be generated by a module using heuristics and/or the one or more processes described herein. The process can be based on a dataset or heuristics. For each of the lookalike domains, a risk score is calculated. The risk score can generally define how likely the domain is to be a phishing domain and more generally, a malicious domain. The alerting can be based on the risk score. The risk score can be calculated from, for example and without limitation, a phishing score, a similarity score, a graphical similarity score, a text similarity score, a context similarity score, or the like. In one embodiment, the calculated risk score can depend on any of a phishing score, a context similarity score, and a graphical similarity score. The phishing score can be a proprietary score provided by the user, customer, or an entity associated with an original domain.

In example only, and without limitation, the method can provide a message based on the similarity score to a customer or user which can read “we detected a domain “mydonain.com” for your “mydomain.com” that is registered under anonymous organization an has a high likelihood to be a phishing domain. Please report this to the appropriate authorities by contacting your domain administrator.” In such an example a non-limiting example, the message can be configured to contain at least one action item.

Advantageously, in typical aspects, the disclosure can include calculating the degree of deceptiveness based directly on the domains themselves, rather than utilizing predefined constants. For example, the method can include calculating the graphical similarity between the original domain and the lookalike domain to get the score. The graphical comparison can be based on an image or figure which can be derived from the domain. Some methods can include generating a pixelated image based on a domain. For example, an image of the domain can be generated which can define one or more pixels. As used herein, the term “pixelated image” generally refers to an image having one or more individual pixels or tiny squares of color that make up the image and/or become visible. Moreover, the image can define a pixelated space or grid which can define one or more spaces. For example, if there is a space in the grid without a pixel, such a space can be represented with a “0”. Conversely, if there is a space with a pixel, the space can be represented with a “1”. The grid can be a cartesian grid wherein each space can define a coordinate (e.g., (x, y)). The image of the domain can be overlayed on the grid, and the text of the image can be associated with a pixel based on the location thereof.

In some aspects, the calculation can be based on a comparison between the pixels. For example, grids can be overlayed and define a common origin, and the number of pixels in the same space can be compared. More generally, the disclosure provides a comparison of the number of pixels similarly disposed between the pixelated images of the domains. In example, and without limitation, the calculation can be based on pixel comparison under the assumption that a relatively small amount of changed pixels can correlate with a more deceptive domain. In other words, the lower the quantity of changed pixels between the two pixelated images, the higher the likelihood that the domain is deceptive and part of a phishing attack. Conversely, a high number of changes will not be confusing and can result in a low similarity score which can indicate a low likelihood of the domain being used for phishing attacks.

Some aspects of the present disclosure can include creating and using a pixel similarity process. The pixel similarity process can be configured to detect how similar two or more domains appear, for example based on an image created therefrom. The process can include one or more stages of accomplishing the same. For example, the process can include any of converting the domains to images, comparing the images, calculating graphical similarity, employing a sliding window enrichment, and usage for all the generated lookalike domains. More generally, the process can be used to calculate more accurate scores as a result of relying on a graphical comparison of similarity being part of the total risk score.

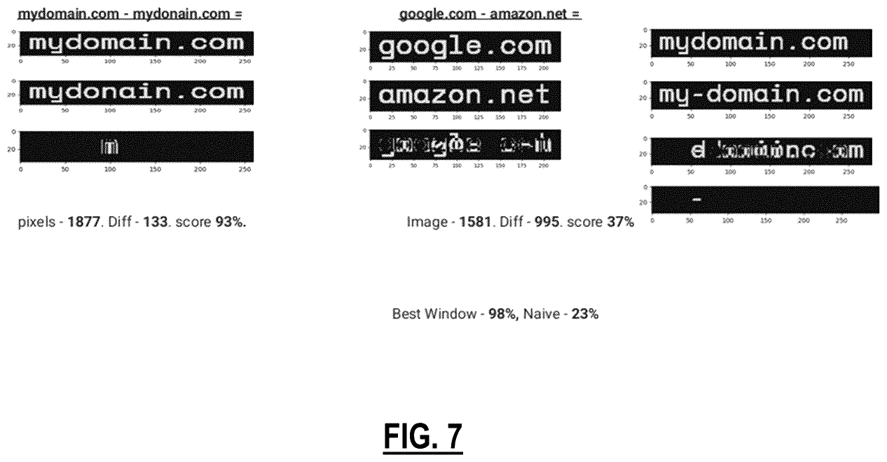

Turning now to FIG. 7, a tabular view of the implementation of the pixel similarity process is shown and described. The method can include creating a pixelated image of at least two domains. For example, the method can create a pixelated image of an original target domain and a lookalike domain. A portion of the domain, for example, the text, can be converted into an image, such as a pixelated image. The pixelated image can be overlayed on a grid, wherein the pixels of the pixelated images can occupy a plurality of the spaces of the grid based on their location. The grids of the images to be compared can be aligned based on a common origin, such that the spacing of the grid can be common between the two images. More generally, the pixelated images can be configured to compare the location of the pixels between the images. The method can include any of converting the domains to images, such as pixelated images, subtracting the domains, wherein the difference between the pixel locations is subtracted, calculating the score, and incorporating a sliding window logic. The subtraction can be configured to define pixels which are not in common. For example, if the comparison finds a pixel that is commonly located between the two pixelated images, the subtraction can remove it from consideration. Thus, what is left is essentially the pixels of the pixelated images which are not commonly shared. More generally, the subtraction can determine the number of similar and dissimilar pixels between the pixelated images. The greater the difference or more dissimilar pixels, the lower the likelihood of confusion between the original target domain and the lookalike domain and therefore lower similarity score.

The method can include incorporating a sliding window logic. As used herein, the term “sliding window logic” generally refers to a technique involving traversing a sequence, such as an array or a string, by maintaining a subset of elements (“window”) over a portion of the sequence. The “window” can be dynamically adjusted incorporating the sliding window logic process, essentially “sliding” over the data. The sliding window can either expand or shrink the window based on specific conditions. The window can define a contiguous subset of elements in a sequence. As the method “slides” the window, the window can move by one element at a time (or in larger steps if needed). The size of the window can be fixed or variable, depending on the problem. Advantageously, instead of recalculating from scratch every time the window moves, the sliding window reuses previously computed information to update the window efficiently. The sliding window as used herein can include, but is not limited to, a fixed-size window or a variable sized window.

More particularly, the sliding window feature allows one of the two domains to be translated after it is converted to a pixelated image. This is useful when the deception technique includes an addition of a character such as a hyphen. This can be shown in FIG. 7, where before implementation of the sliding window feature, the similarity score of the domains “mydomain.com” and “my-domain.com” is 37%. After implementation of the sliding window feature, the similarity score of these two domains is a much more accurate 98%, showing the hyphen as the only difference between the domains.

The graphical communication can be an improvement over the state of the art because of the increased accuracy in comparison. One aspect of the present disclosure can include an External Attack Surface Module (EASM) which can be configured to combat lookalike domains. In other words, the EASM can include a domain lookalike detection. The purpose of such model can be to generate all of the optional lookalike domains for the customer's domain and to optionally calculate a risk therefrom. In accordance with the risk score therefrom, the method can suggest at least one action item regarding the lookalike domains. The method can include generation of some or all permutations of the lookalike domains using, for example and without limitation, a genetic algorithm and/or a heuristic. The method can base the generation on a deception method. The deception method can be, for example, any of EdgeInsertion, Extension, Homographs, Hyphenation, keyBoardTypos, MidInsertion, Omission, PhoneticReplacment, Repetition, TldSwap, Typoglycemia, Typos, and vowelSwap. More generally, the deception method can be any technique used to mislead or confuse cyber attackers by creating fake attack surfaces or vulnerabilities.

In some aspects, the method can calculate the risk score based on a plurality of scores. In example, the method can calculate the risk score using three different scores, such as real phishing score, context similarity score, and the graphical similarity score. In such case, the phishing score can be a high risk score and can be the determining score that will receive the most weight in the calculation relative to the remaining scores. In other embodiments, the scores can be weighted similarity, for example the graphical similarity and the graphical similarity can receive similar weighting based on the alternation method. In some embodiments, Extensions, Hyphenation and TldSwap are mainly context similarity, and the rest of the alternations will be graphical similarity. As such, the present advantages of graphical comparison are show and is why there is the need to for the present model to calculate the similarity score based on the method or algorithm. In typical aspects, all of the scores can be calculated for each couple and a total risk score can be generated. The total risk score can represent a combination of the one or more individual scores and optionally their assigned weights. The total risk score can be displayed in the EASM user interface (UI) for the customer along with some suggested action items. Moreover, the alert can display the total risk score.

In example only, the similarity score process can calculate for each couple of original/target domain and lookalike domain the similarity score by the pixel comparison method. The method can work in few stages. First it converts the two domains into images, the images will be on the same size and will be black-white (0,1) values. The second stage can be to calculate the difference between the two images in respect of every pixel. The third stage can be to calculate the different pixels percentage, Next, the method can calculate the pixels that are used in the original domains and the number of different pixels between the images and then calculate the lookalike percentage between the domains. The fourth stage can be to add sliding window logic that will try to add a one-word gap between every letter to find the best lookalike permutation and it will be the similarity score.

As disclosed, there are several advantages over the prior art insofar as using a graphical comparison. For example, the method of the disclosure can generate a more reliable and calculated similarity score which can determine the total risk score of the lookalike domain and the suggested action items therefrom. Further, the method can generate a more accurate similarity score that can relate or indicate a more stable information risk score. The new score can be used in future iterations to generate alerts to the customer regarding potential phishing domains and risky or malicious domains which should be handled. Moreover, each lookalike in each alteration of the methods herein can have a variety of scores which can provide increased reliability.

### § 7.1 Example of Graphical Comparison

The following is an example of a graphical comparison which can be completed via the methods disclosed in the instant application. Notwithstanding, the foregoing is intended for illustrative purposes only and is not intended to limit the scope of the disclosure.

The methods disclosed herein can be a part of an EASM product as a domain lookalike feature that can detect phishing domains for a customer. The method can include calculating the risk score of a lookalike domain. The method can include an alert which can alert the customer of a potential phishing attack. The service can reveal foot traces of the lookalike domains and suggest preventative measures against future attempts. The method can calculate the risk score of a domain based on one or more components, such as graphical similarity, which refers to how similar the domains are looking to the eye (e.g., “domain.com” vs. “domein.com” is more similar than “domain.com” vs. “doomaain.com”, the context similarity, which refers to the similarity score that is depended on the context, and phishing score, which can be for example phishing score that describes estimated phishing possibility.

The score can be calculated and combined in various different ways depending on the deception methods. The scores can be used to alert the customer which lookalike domains have a higher risk score and can be used to indicate on the suggestion action items for the customer. The method can compare the original target domain and the lookalike domain and will return a similarity score based on the pixel comparison. The method can convert the domains to images, such as pixelated images, compare the images, calculate the similarity score, and employ a sliding window enrichment. The images and define a size, for example a height of 35 pixels and 100 pixels wide. The pixelated images can be displayed or represented in black-white images with 0,1 values only. The method can subtract both images which can show the difference between the images.

The calculation can count the number of pixels used in the pixelated images of the domain and the number of pixels in the difference. For example, the method can generate another image which displays the different pixels. The difference images can display the pixels that do not match in the comparison between the original target domain and the lookalike domain. The number of pixels in the different image can be the difference.

The method can subtract the number of pixels in the different image from original domain's image to generate a score. In general, the score can be as follows:

$$score \% = \frac{{NP}_{domain} - {NP}_{difference}}{{NP}_{domain}}$$

### Where:

Score % is the percentage score and NP is the number of pixels, either in the domain or difference image.

The method can employ the sliding window to calculate similarity. The sliding window can be used to increase the accuracy when confronted with deception methods, such as Edge Insertion. For example, the Edge Insertion can generate a large, calculated difference. The sliding window can be configured to determine the best similarity despite such deception methods. The method can save the similarity score in a report and use the saved score to calculate the total risk score of the lookalike domain. The method can include a unique calculation depending on the graphical similarity score, context score, and phishing score. The risk score can incorporate other factors like the registration of the domain and other variables. More generally, the method can provide a mathematical solution to calculate how the domains are similar to the eye and how potentially confusing they can be.

### § 7.2 Process for Graphical Similarity Pixel Comparison

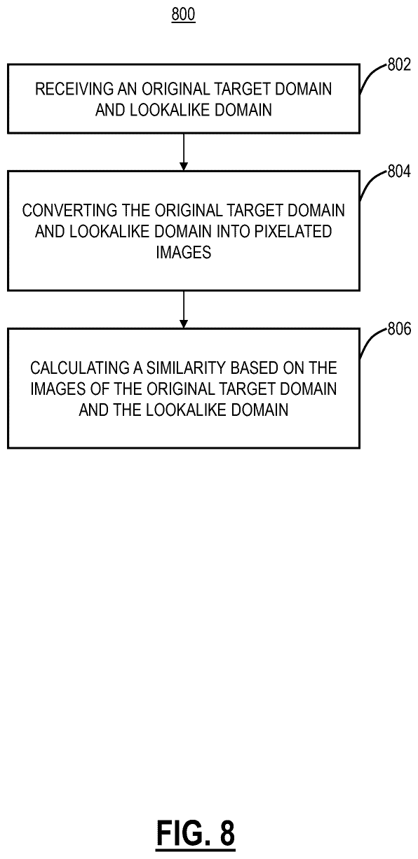

Turning now to FIG. 8, a method 800 for determining a similarity between lookalike Uniform Resource Locators (URLs) or domains and an original target domain based on Graphical Similarity Pixel Comparison in accordance with one aspect of the present disclosure is shown and described. In some aspects, the method 800 can include receiving an original target domain and lookalike domain (step 802). The method can include converting the original target domain and lookalike domain into pixelated images (step 804). The method can include calculating a similarity based on the images of the original target domain and the lookalike domain (step 806).

The method can include providing a similarity score based on the similarity. The images can be converted to a same size and to black and white (0,1) values. The method can include wherein the calculating the similarity is based on the similarity of the pixels of the target domain and lookalike domain images. The method can include calculating a percentage difference based on the pixels in the original target domain and a quantity of different pixels between the original target domain and the lookalike domain. The method can include wherein the sliding window logic is configured to add a one-word gap between every letter. The method can include wherein the similarity score is any of a real phishing score, a context similarity score, and a graphical similarity score. The method can include displaying a notification for a customer based on the score. The method can include adding a sliding window logic adapted to determine a best lookalike permutation. The method can include generating a list of one or more possible lookalike domains. The method can include utilizing the lookalike domains for performing one or more functions.

### § 8.0 Domain Lookalike Phishing Detection

Detecting domain lookalikes is a vital function in cybersecurity aimed at identifying malicious domains designed to impersonate legitimate websites for phishing attacks. These deceptive domains are often crafted to trick users into sharing sensitive information, making their detection essential for preventing security breaches. Historically, domain lookalike detection has relied heavily on comparing visual similarities and employing contextual matching algorithms to uncover potential threats. While these methods can identify suspicious patterns, they are prone to generating large volumes of false positives, complicating efforts to discern between harmless domains with coincidental similarities and those with malicious intent. This lack of precision has exposed a critical weakness in current domain monitoring practices, the absence of a comprehensive risk assessment framework capable of reliably predicting whether a domain is likely to be weaponized for phishing activities. As a result, security teams frequently face the daunting task of sifting through countless alerts without clear criteria for prioritization. This not only drains valuable time and resources but also risks overlooking genuine threats that could cause significant harm. Addressing this issue requires a transformative approach that goes beyond traditional methods. Incorporating advanced threat intelligence and phishing-specific indicators into detection processes can significantly improve accuracy, reduce false positives, and enable more actionable insights, ensuring security teams can channel their efforts into protecting against truly harmful attacks effectively.

The present invention introduces a groundbreaking approach to domain lookalike detection by integrating a dedicated phishing risk assessment score, referred to as the “phishing score,” as the primary indicator in the evaluation process. This innovative method redefines the accuracy, reliability, and actionability of domain lookalike detection frameworks by making the likelihood of phishing activity a central factor in risk determination.

At its core, the enhanced detection system utilizes a multi-phase process that begins by leveraging established genetic algorithms and heuristic techniques to generate a comprehensive set of permutations based on customer domains. These permutations are crafted using a variety of deception strategies, including EdgeInsertion, Extension, Homographs, Hyphenation, keyBoardTypos, MidInsertion, Omission, PhoneticReplacment, Repetition, TldSwap, Typoglycemia, Typos, and vowelSwap. Together, these techniques create an exhaustive list of potentially deceptive domains, or “lookalike domains,” designed to mimic legitimate websites.

Once these domain permutations are generated, the system integrates its core innovation, the phishing score. For each registered domain generated by the system, a detailed phishing likelihood analysis is conducted. This analysis incorporates multiple specialized security parameters to assess the risk of phishing activities. These factors include domain and URL analysis (such as TLD risk evaluation and the detection of suspicious patterns), technical infrastructure validation (including SSL certificate analysis and autonomous system risk evaluation), content inspection (covering file type risks, malicious hash verification, and YARA signature detection), and reputation-based intelligence (cross-referencing known malicious databases and phishing heuristic indicators). The phishing score, calculated using these layered security metrics, is then combined with traditional domain similarity metrics through a dynamic weighting procedure.

The dynamic weighting process is a key innovation of the framework. It ensures that the influence of the phishing score on the final risk assessment is adjusted based on its predictive value. For domains with high phishing indicators (high phishing scores), the phishing score accounts for up to 90% of the final risk score, recognizing its critical importance. Conversely, for domains with low or negligible phishing indicators, traditional similarity metrics such as graphical and contextual comparisons are given greater weight. For domains exhibiting moderate phishing scores, the system dynamically balances phishing indicators and similarity metrics to provide a nuanced risk evaluation. The final risk score considers additional factors, such as external domain verification (assigning zero risk to internal domains automatically), registration status, acquisition feasibility, and a breakdown of phishing score components.

Based on the comprehensive risk score, the system classifies domains into distinct risk categories: “Phishing” (domains associated with active phishing campaigns), “Registered” (domains showing moderate risk but are already in existence), “Preventative” (unregistered but high-risk domains), “Company-Owned” (domains formally owned by the customer organization), and “Watchlist” (domains requiring monitoring without immediate threat indicators). Each category is coupled with specific recommended actions for security teams, ensuring prioritization and clear next steps in defending against domain-targeted threats.

This novel invention represents a significant leap forward in the domain lookalike detection space. By shifting the focus from mere visual and contextual similarity to actual phishing likelihood, the system reduces false positives, enabling security teams to concentrate on genuine threats. The comprehensive risk assessment process ensures actionable intelligence, offering clear recommendations tailored to each domain's risk level. The use of a flexible weighting system allows the invention to adapt dynamically to varying threat scenarios, further optimizing security efforts. By transforming domain lookalike detection into a multidimensional assessment tool, this system provides a powerful and efficient countermeasure against domain-based phishing attacks, minimizing false positives and negatives while enhancing overall security outcomes. Security teams now have access to more meaningful alerts rooted in real phishing probabilities, enabling them to respond effectively to the most pressing threats.

The phishing score component is a sophisticated security analysis tool designed to evaluate URLs and domains for signs of phishing or malicious content. Its comprehensive framework incorporates multiple layers of specialized security checks to identify subtle and overt indicators of potential threats effectively. By leveraging advanced detection techniques across several critical vectors, domain analysis, technical infrastructure assessment, content inspection, and reputation-based intelligence, this system provides an in-depth evaluation that enhances accuracy while minimizing false positives.

The phishing score begins with an investigation of domain and URL characteristics. It performs a Top-Level Domain (TLD) risk assessment, which evaluates the inherent risk associated with specific TLDs, such as “.com” or “.org,” based on their usage patterns and historical associations with phishing. Suspicious URL pattern detection uses regex-based matching to identify potentially malicious structures in URLs, such as excessive special characters or non-standard formats. Non-standard port analysis flags any instances where connections utilize uncommon ports, which can often indicate illicit or obfuscated activity. Additionally, the system conducts a Spam URI Realtime Block List (SURBL) block verification to detect malicious patterns, such as specific IP blocks marked with identifiers like “127.0.0.x”.

Another critical layer involves analyzing the technical underpinnings of a domain. SSL certificate validation meticulously examines certificate validity, age, issuer reputation, and adherence to cryptographic standards, recognizing the security implications tied to certificate quality. Autonomous System (AS) risk assessment maps the network infrastructure to detect high-risk autonomous systems that may host or facilitate phishing operations. The system also incorporates geo-location risk calculation, evaluating the hosting region's threat level, as certain geographical areas are statistically more prone to malicious activities. To identify domains that may have been repurposed for phishing campaigns, it applies parked/disabled domain detection, utilizing YARA signatures tailored for this purpose. Lastly, it performs a NetBlock size risk evaluation, assessing risks associated with IP address block allocations; larger blocks (e.g., /12) may indicate reduced administrative oversight, a factor commonly exploited by threat actors.

The phishing score includes robust content inspection capabilities to identify harmful files and code. File-type risk evaluation scans file headers and extensions to detect known malicious patterns associated with phishing payloads. The content inspection engine applies YARA signature detection to locate embedded malicious code within files, enhancing its ability to identify threats that evade traditional detection methods. Known bad hash verification leverages MD5 hash databases of confirmed malicious files, ensuring swift identification of previously discovered threats. Additionally, the system integrates a VirusTotal content check, querying VirusTotal's API to compare files against multiple antivirus engines, gaining broader insight into potential risks.

A key component of the phishing score is its integration with reputation-based intelligence systems. Malicious URL database checks cross-reference URLs against proprietary security databases to uncover known malicious links, while malicious IP verification identifies suspicious activity tied to specific IP addresses using threat intelligence sources. Furthermore, phishing heuristic analysis employs specialized algorithms to assess the likelihood of phishing attempts based on behavioral patterns and indicators in the domain configuration. Inline category verification dynamically categorizes content in real-time, ensuring up-to-date threat detection. Finally, VirusTotal IP submission evaluates the associated IP address against VirusTotal's database, leveraging a calculated “badness ratio” from aggregated security vendor assessments.

This multilayered analysis culminates in a scoring system that synthesizes detection results from all vectors through a dynamic weighting process. By prioritizing indicators with higher predictive accuracy and contextual relevance, the phishing score minimizes false positives while maximizing detection of genuine phishing threats. Through this holistic assessment methodology, security teams are empowered with actionable intelligence that enables them to respond effectively and efficiently to evolving threat landscapes.

The phishing detection system calculates a comprehensive score, known as the “phishing score,” by synthesizing weighted results across multiple layers of analysis. Each layer evaluates distinct aspects of the domain or URL, with internal components assigned specific weights based on their significance in identifying phishing activity. The domain and URL analysis layer, which, in this example, contributes 30% to the final phishing score, focuses on evaluating characteristics like TLD risk, suspicious URL patterns, non-standard ports, and matching against SURBL. Suspicious URL patterns are given the highest weight (40%) in this layer due to their strong association with phishing behavior, while other indicators such as TLD risk, port analysis, and SURBL verification each contribute 20% as supporting data points.

The technical infrastructure evaluation layer accounts for, in this example, 25% of the phishing score and examines the underlying technical aspects of the domain's hosting environment. This includes SSL certificate validation, autonomous system risk assessment, geo-location risk calculation, parked or disabled domain detection, and risks related to IP block sizes. SSL certificate validation receives the greatest weight (30%) in this layer, reflecting its importance as a trustworthiness indicator, while AS and geo risks contribute 20% each due to their relevance to hosting reputation. Parked domain detection and NetBlock size analysis are secondary indicators, each weighted at 15%.

The system's content analysis layer, contributing 20% of the phishing score in this example, evaluates files and patterns embedded within the domain for harmful content. It incorporates file-type risk evaluation, content inspection, malicious hash verification, and Virus Total API checks to identify known threats. Content inspection, which applies advanced techniques like YARA signature detection to examine behavioral patterns, is weighted at 30% due to its high predictive value. Hash verification and VirusTotal comparison each contribute 25%, ensuring rigorous detection of previously confirmed malicious payloads. File-type risk evaluation complements these components, providing baseline insights with a 20% weight.

Reputation systems integration forms the final layer, accounting for 25% of the phishing score in this example. This layer uses reputation-based intelligence to assess the domain's or IP's credibility and malicious history through components like malicious URL and IP database checks, phishing heuristic analysis, inline categorization, and VirusTotal IP verification. Phishing heuristic analysis is weighted the highest (30%) due to its tailored algorithms for detecting phishing attempts, while malicious URL and IP checks each contribute 25%, leveraging enterprise-grade threat intelligence. Inline categorization and Virus Total IP verification provide supplementary data at 10% each.

The phishing score calculation combines these layers into a weighted sum. For example phishing_score=(Domain_Score×0.30)+(Infrastructure_Score×0.25)+(Content_Score×0.20)+(Reputation_Score×0.25). This prioritizes high-impact indicators like suspicious URL patterns, SSL certificate validity, and phishing heuristics while incorporating secondary data to reinforce the evaluation. By integrating multiple dimensions of analysis, the system delivers a nuanced phishing likelihood assessment, reducing false positives and negatives. The dynamic weighting ensures that the final score accurately reflects the risk of malicious activity, equipping security teams with actionable intelligence to effectively prioritize and address potential threats.

The present system integrates supporting components, such as graphical and contextual similarity evaluations, alongside domain registration patterns and attributes, into its comprehensive risk assessment framework. Graphical similarity assessment examines the visual resemblance of suspicious domains to legitimate ones, a technique detailed herein. Contextual similarity evaluation takes a logical approach, analyzing how the suspicious domain compares in context to known safe domains. Additionally, the system reviews domain registration patterns and attributes, such as creation dates, ownership information, and other metadata, which can provide vital insights into the intent behind the domain's presence.

These supporting elements are combined with a prominent emphasis on the phishing score, which remains the cornerstone of the evaluation process. By leveraging this scoring system, the detection framework generates actionable intelligence regarding potential phishing threats that empower organizations to prioritize their responses effectively. This approach is particularly effective in distinguishing between legitimate domains with similar characteristics and those that are likely crafted for malicious purposes. Through a detailed multidimensional analysis, the scoring system provides improved accuracy in assessing risks and delivers targeted response recommendations tailored to the specific threat level. As a result, organizations can reduce false positives, focus resources on credible threats, and maintain greater control over domain-based security challenges.

The implementation of the enhanced domain lookalike detection system follows a structured, multi-phase approach designed to identify, evaluate, and respond to potential phishing domains with high precision. The process begins with the generation phase, where the system generates all possible lookalike domains for a given customer's owned domain using the processes described herein as well as other processes known in the art. This phase creates a comprehensive set of potentially deceptive domains through permutations such as character substitutions, additions, and other similarity-based variations, providing a robust foundation for threat monitoring.

Next, the phishing detection integration phase analyzes registered domains within the generated set, those that have active ownership. Each registered domain is submitted to the system for detailed phishing analysis using its advanced evaluation techniques, as described herein. The system assesses these domains using specialized checks, ultimately producing a numerical phishing score that quantifies the likelihood of the domain being used maliciously.

The risk score calculation phase employs a multi-layered methodology to determine the risk level associated with each domain. This phase begins with external domain verification, where domains external to the customer's organization are validated, and internal domains receive a risk score of 0 as they are inherently safe. Similarity score analysis evaluates the graphical and contextual resemblance of the domain to legitimate ones, combining lookalike rank scores with varying weights depending on the detection method, for example, 90% graphical+10% general for graphical methods, 100% general for contextual methods, and a balanced 50/50 split for other methods. Business assessment integrates practical elements like domain registration status and acquisition cost into the risk calculations. The formula applied (0.5×registration_status+0.5×similarity_score²−buy_price^{0.4}/100) assigns higher risk weights to registered domains while factoring in purchase price as a risk reducer.

For registered domains, the risk score calculation combines phishing scores with broader risk assessments, dynamically adjusting the weight of the phishing score based on confidence levels. Domains with high phishing scores exert up to 90% influence on the overall risk score, while those with low phishing scores only contribute 10%. Moderate phishing scores use balanced weighting between phishing indicators and overall risk metrics. Based on the finalized score, domains are categorized into distinct risk levels, Phishing, Registered, Preventative, Company-Owned, or Watchlist, with corresponding action recommendations tailored to each category.

Finally, the Alert and Response System Phase activates when a domain's risk score exceeds the predefined threat threshold. The system flags such domains as high-risk and generates prioritized alerts to notify customers promptly. These alerts include detailed information about the threat level, comprehensive risk analysis, and recommended actions to mitigate the identified risks. By leveraging this adaptive scoring system, the detection process enhances accuracy, reduces delays, and empowers organizations to respond effectively to domain-based phishing threats. This systematic implementation not only minimizes false positives but also ensures timely identification of credible threats, enabling proactive defense measures tailored to various domain characteristics and evolving threat scenarios.

### § 8.0 Process for Domain Lookalike Phishing Detection

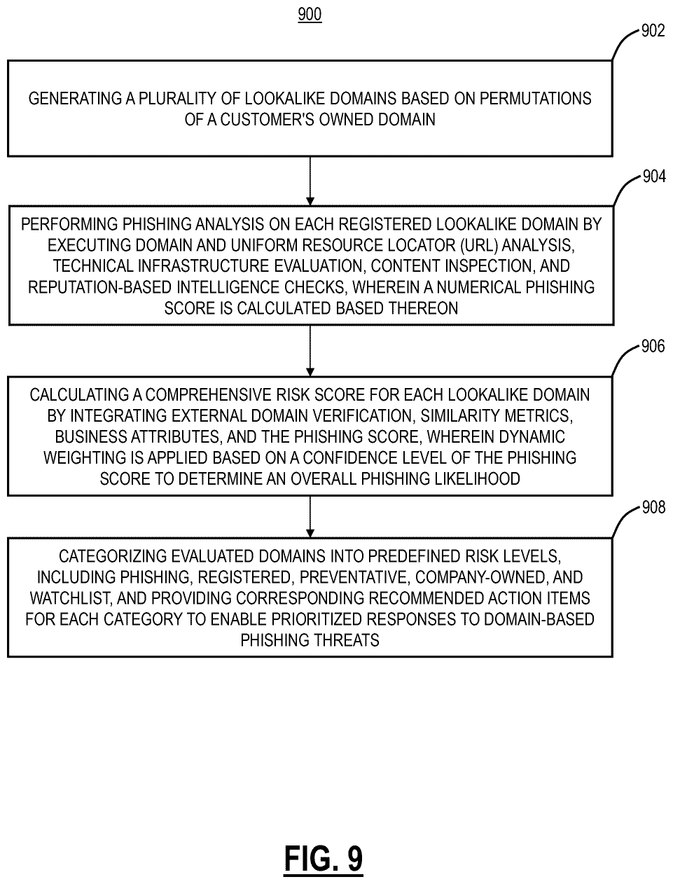

FIG. 9 is a flowchart of a process for domain lookalike phishing detection. The process 900 includes generating a plurality of lookalike domains based on permutations of a customer's owned domain (step 902); performing phishing analysis on each registered lookalike domain by executing domain and Uniform Resource Locator (URL) analysis, technical infrastructure evaluation, content inspection, and reputation-based intelligence checks, wherein a numerical phishing score is calculated based thereon (step 904); calculating a comprehensive risk score for each lookalike domain by integrating external domain verification, similarity metrics, business attributes, and the phishing score, wherein dynamic weighting is applied based on a confidence level of the phishing score to determine an overall phishing likelihood (step 906); and categorizing evaluated domains into predefined risk levels, including phishing, registered, preventative, company-owned, and watchlist, and providing corresponding recommended action items for each category to enable prioritized responses to domain-based phishing threats (step 908).

The process 900 can further include wherein the generated permutations of lookalike domains in the generation phase include advanced techniques such as character substitutions based on homographs, vowel swaps, mid-insertions, and keyboard typos, further broadening the scope of potentially deceptive domain identification. Additionally, the phishing detection system performs domain and URL analysis using methods like top-level domain risk assessment, regex-based pattern matching to detect suspicious URL structures, non-standard port detection, and cross-referencing against Spam URI Real-time Block Lists (SURBL), ensuring rigorous evaluation of phishing risks.

The technical infrastructure evaluation leverages SSL certificate validation to assess certificate validity and reputation, autonomous system risk assessment to analyze hosting infrastructure, geo-location risk calculation to quantify risks associated with hosting regions, and parked or disabled domain detection using YARA signatures to uncover domains repurposed for phishing activity. The content inspection process further enhances detection accuracy by incorporating file-type risk evaluation using file headers and extensions, YARA signatures for behavioral detection, known bad hash verification to identify previously flagged threat vectors, and querying the VirusTotal API for intelligence gathered across multiple antivirus engines.

In another embodiment, the phishing score calculation dynamically adjusts weighting for each layer's components based on their associated predictive value, giving high-confidence phishing indicators up to 90% influence on the final risk score of the domain. Business attributes such as domain registration status and acquisition costs are incorporated into the risk score calculation to refine accuracy, with registered domains assigned higher risk scores, while acquisition price acts as a risk-reducing factor.

Furthermore, the system enables reputation-based intelligence checks, including malicious URL database cross-referencing, phishing heuristic algorithm evaluations, inline category matching, and VirusTotal IP verification, integrating these data sources to calculate a “badness ratio” for linked IP addresses. Dynamic weighting in the risk score phase also adapts over time based on external threat intelligence updates, enabling the model to evolve in response to changing phishing techniques and domain-based threat patterns.

Categorized domains flagged as “Phishing” are assigned high-priority status to prompt immediate countermeasures, such as DNS-level blocking or reporting to relevant authorities. Parallel processing techniques are employed within the content inspection phase to accelerate behavioral pattern matching and YARA signature detection when analyzing large-scale datasets of domains. Lastly, the method includes identifying unregistered but high-risk domains during the generation phase and recommending their preemptive acquisition by the customer to proactively mitigate future phishing threats. These enhancements collectively ensure the method's adaptability, scalability, and effectiveness in addressing varying threat scenarios.

### § 9.0 Conclusion

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. A method for detecting and assessing risk of phishing domains, the method comprising steps of:
generating a plurality of lookalike domains based on permutations of a customer's owned domain;
performing phishing analysis on each registered lookalike domain by executing domain and Uniform Resource Locator (URL) analysis, technical infrastructure evaluation, content inspection, and reputation-based intelligence checks, wherein a numerical phishing score is calculated based thereon;
calculating a comprehensive risk score for each lookalike domain by integrating external domain verification, similarity metrics, business attributes, and the phishing score, wherein dynamic weighting is applied based on a confidence level of the phishing score to determine an overall phishing likelihood; and
categorizing evaluated domains into predefined risk levels, including phishing, registered, preventative, company-owned, and watchlist, and providing corresponding recommended action items for each category to enable prioritized responses to domain-based phishing threats.

2. The method of claim 1, wherein the plurality of lookalike domains are generated using character substitutions, additions, and similarity-based variations.

3. The method of claim 1, wherein the phishing analysis includes domain and URL analysis using top-level domain risk assessment, regex pattern matching for suspicious URLs, non-standard port detection, and Spam URI Real-time Block List (SURBL) verification.

4. The method of claim 1, wherein the technical infrastructure evaluation includes Secure Socket Layer (SSL) certificate validation, autonomous system risk assessment, geo- location risk calculation, and parked/disabled domain detection using Yet Another Recursive Acronym (YARA) signatures.

5. The method of claim 1, wherein the content inspection includes file-type risk evaluation, content inspection using Yet Another Recursive Acronym (YARA) signatures, bad hash verification, and VirusTotal Application Programming Interface (API) querying for content-based intelligence.

6. The method of claim 1, wherein the phishing score dynamically adjusts weighting for each of the URL analysis, technical infrastructure evaluation, content inspection, and reputation-based intelligence checks based on their predictive value.

7. The method of claim 1, wherein the comprehensive risk score incorporates business attributes by analyzing domain registration status and purchase cost.

8. The method of claim 1, wherein similarity metrics are determined via graphical methods and contextual methods.

9. The method of claim 1, wherein the reputation-based intelligence checks include malicious URL database cross-referencing, phishing heuristic algorithms, inline category checks, and Virus Total Internet Protocol (IP) verification to aggregate threat intelligence and calculate an associated risk for associated IP addresses.

10. The method of claim 1, wherein the generated lookalike domains are stored in a database of potential threats and monitored for future registration changes or updates.

11. A non-transitory computer-readable medium comprising instructions that, when executed, cause one or more processors to perform steps of:
generating a plurality of lookalike domains based on permutations of a customer's owned domain;
performing phishing analysis on each registered lookalike domain by executing domain and Uniform Resource Locator (URL) analysis, technical infrastructure evaluation, content inspection, and reputation-based intelligence checks, wherein a numerical phishing score is calculated based thereon;
calculating a comprehensive risk score for each lookalike domain by integrating external domain verification, similarity metrics, business attributes, and the phishing score, wherein dynamic weighting is applied based on a confidence level of the phishing score to determine an overall phishing likelihood; and
categorizing evaluated domains into predefined risk levels, including phishing, registered, preventative, company-owned, and watchlist, and providing corresponding recommended action items for each category to enable prioritized responses to domain-based phishing threats.

12. The non-transitory computer-readable medium of claim 11, wherein the plurality of lookalike domains are generated using character substitutions, additions, and similarity-based variations.

13. The non-transitory computer-readable medium of claim 11, wherein the phishing analysis includes domain and URL analysis using top-level domain risk assessment, regex pattern matching for suspicious URLs, non-standard port detection, and Spam URI Real-time Block List (SURBL) verification.

14. The non-transitory computer-readable medium of claim 11, wherein the technical infrastructure evaluation includes Secure Socket Layer (SSL) certificate validation, autonomous system risk assessment, geo-location risk calculation, and parked/disabled domain detection using Yet Another Recursive Acronym (YARA) signatures.

15. The non-transitory computer-readable medium of claim 11, wherein the content inspection includes file-type risk evaluation, content inspection using Yet Another Recursive Acronym (YARA) signatures, bad hash verification, and Virus Total Application Programming Interface (API) querying for content-based intelligence.

16. The non-transitory computer-readable medium of claim 11, wherein the phishing score dynamically adjusts weighting for each of the URL analysis, technical infrastructure evaluation, content inspection, and reputation-based intelligence checks based on their predictive value.

17. The non-transitory computer-readable medium of claim 11, wherein the comprehensive risk score incorporates business attributes by analyzing domain registration status and purchase cost.

18. The non-transitory computer-readable medium of claim 11, wherein similarity metrics are determined via graphical methods and contextual methods.

19. The non-transitory computer-readable medium of claim 11, wherein the reputation-based intelligence checks include malicious URL database cross-referencing, phishing heuristic algorithms, inline category checks, and VirusTotal Internet Protocol (IP) verification to aggregate threat intelligence and calculate an associated risk for associated IP addresses.

20. The non-transitory computer-readable medium of claim 11, wherein the generated lookalike domains are stored in a database of potential threats and monitored for future registration changes or updates.
